(19) United States
(12) Patent Application Publication
(10) Pub. No.: US 2024/0048229 A1
(43) Pub. Date: Feb. 8, 2024

(54) METHOD AND APPARATUS FOR WIRELESS COMMUNICATION USING SATELLITE ACCESS

(71) Applicant: Samsung Electronics Co., Ltd., Gyeonggi-do (KR)

(72) Inventors: Lalith KUMAR, Bangalore (IN); Mahmoud WATFA, Middlesex (GB); Chadi KHIRALLAH, Middlesex (GB)

(21) Appl. No.: 18/366,984

(22) Filed: Aug. 8, 2023

(30) Foreign Application Priority Data
Aug. 8, 2022 (IN) 202231045167
Jul. 6, 2023 (GB) 2310418.5

(51) Int. Cl. H04B 7/185

(52) U.S. Cl. CPC H04B 7/18513

(57) ABSTRACT

The disclosure relates to a 5G or 6G communication system for supporting a higher data transmission rate. A method performed by a UE in a wireless communication system using satellite access is provided. The method includes identifying whether an NAS procedure is completable before a start of a DC; and in case that the NAS procedure is completable before the start of the DC, initiating the NAS procedure by transmitting a request message to a network entity. And a method for a UE in a communications network using a satellite to access the network comprises verifying if a communication process between the UE and the network via the satellite can be completed before a start of an unavailability period of the satellite or cannot be completed before a start of an unavailability period of the satellite. The UE may only initiate the communication process when it verifies that there is enough time for the communication process to be completed the start of the unavailability period of the satellite. The communication process between the UE and the satellite may comprise an NAS procedure. The UE may only trigger the NAS procedure when it verifies that there is enough time for the procedure to be completed before the start of the unavailability period of the satellite and loss of satellite coverage for the UE. The UE may trigger the NAS procedure during a time range for which the procedure can be completed before the start of the unavailability period of the satellite and loss of satellite coverage for the UE. The NAS procedure may be any of a registration procedure, a mobility registration update procedure, an NAS request procedure, an attach procedure, a tracking area update procedure, a service request procedure, an NAS mobility management procedure, an NAS session management procedure, NAS signaling, an NAS message, any similar message that is used in EPS (or in S1 mode).

### CROSS-REFERENCE TO RELATED APPLICATION(S)

This application is based on and claims priority under 35 U.S.C. § 119 to Indian Patent Application No. 202231045167, which was filed in the Indian Patent Office on Aug. 8, 2022, and to United Kingdom Patent Application No. 2310418.5, which was filed in the Intellectual Property Office (IPO) on Jul. 6, 2023, the entire disclosure of each of which is incorporated herein by reference.

### BACKGROUND

### 1. Field

The disclosure relates generally to enhancements for user equipment (UE)—satellite access, and more particularly, to UE—satellite access within a 3^{rd} Generation Partnership Project (3GPP) 5^{th} Generation (5G) communication network.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

3G PP is developing solutions for the use of satellite access for connecting UEs, such as Internet of things (IoT) devices, to core networks, such as an evolved packet core (EPC).

An aspect of satellite use is discontinuous coverage (DC), in which a satellite's coverage is not always available for a UE, and hence satellite access is discontinuous. The lack of availability of satellite coverage for a UE may be due to the movement of the satellite around the planet. For example, when the satellite is near the UE, the UE will have coverage from the satellite. When the satellite is moving around the planet, a certain time being required for a full circle to be made, the UE will not have coverage from the satellite. When the satellite is again near the UE, the UE will again have coverage from the satellite. In the presence of the satellite, and hence coverage, the concept of fly-over time is discussed which is basically the duration for which coverage is available to the UE. For example, it may take a satellite 10 hours to go around the Earth at a certain orbit or distance, and the satellite may have a fly-over time for a UE on Earth of only 2 minutes. Accordingly, the UE on Earth will only detect coverage for 2 minutes, every 10 hours.

Additionally, when using satellite communication, a UE will not be able to send any message if it does not have the satellite location or position. The time required to the satellite location or position is referred to as a time to first fix (TTFF). The duration of the TTFF may depend on the state of the UE receive function, i.e., cold, warm, or hot. The 3GPP radio access network working group 2 (RAN2) has assumed certain example values, such that a global navigation satellite system (GNSS) fix can take up to 100 seconds from a cold state, 50 seconds from a warm state, and 2 seconds from hot state.

When a UE is using satellite access, non-access stratum (NAS) timers that guard NAS procedures are extended, so as to give enough time for lower layer transmissions of the UE to succeed and for a response to arrive at the UE from a message recipient. For example, a timer T3517 (in an N1 mode) for the service request procedure (e.g., for which the UE sends the Service Request message) is 15 seconds when the UE is not using satellite access. However, when satellite access is used, this timer is set to 27 seconds because the lower layer transmissions in satellite access are expected to require more time to transmit a message. Setting the timer to 15 seconds would lead to an early failure of the NAS procedure, even if the response message may be received a few seconds after the 15 seconds time mark. To avoid this, the NAS timers have been extended in TS 24.301 and TS 24.501. The NAS timers may have different names in an S1 mode compared to the N1 mode and may also have different values depending on whether the UE is using a narrow band, a wide band, etc.

To date, a number of problems have been identified with the above-described operations.

For example, assuming that a satellite's flyover time starts at T1 and it is expected to last until T1+60 s, at time T2, where T2=T1+50 s, i.e., 50 seconds into the flyover time, the satellite is expected to provide coverage for an additional 10 seconds. A UE in idle mode may have data or signaling to send at T2, which means that the UE only has 10 seconds left to complete the service request procedure, for which the NAS timer is to be set at 27 seconds. However, the remaining 10 seconds of flyover time would likely be insufficient for the completion of the NAS procedure. Therefore, it is highly likely that the NAS procedure will be unsuccessful due to insufficient coverage time. A failed NAS procedure means that the UE will have wasted power during the failed NAS procedure. As described above, NAS timers may be different in an S1 mode and also the timer values may be different and can be longer than the example used above.

UE battery life is very important to preserve. A UE may need to perform a communication process before the start of the DC. However, if the UE performs a communication process at the time when a DC event starts (i.e., when the satellite becomes unavailable), then the UE will waste power because the process will not be completed before the satellite coverage is discontinued. This negatively impacts the UE battery life, since the power used for the failed communication process is wasted. Even if the UE is able to send a message in the communication process, there may not be enough time for the network to complete the communication process. This will also unnecessarily cause signaling to increase in the communication network.

### SUMMARY

The disclosure has been made to address at least the above-mentioned problems and/or disadvantages and to provide at least the advantages described below.

An aspect of the disclosure is to provide efficient communication methods in a wireless communication system.

Another aspect of the disclosure is to provide a terminal and a communication method thereof in a wireless communication system.

In accordance with an aspect of the disclosure, a method performed by a UE in a wireless communication system using satellite access is provided. The method includes identifying whether an NAS procedure is completable before a start of a DC; and in case that the NAS procedure is completable before the start of the DC, initiating the NAS procedure by transmitting a request message to a network entity.

In accordance with another aspect of the disclosure, a UE is provided for use in a wireless communication system using satellite access. The UE includes a transceiver; and a processor coupled with the transceiver and configured to identify whether an NAS procedure is completable before a start of a DC, and in case that the NAS procedure is completable before the start of the DC, initiate the NAS procedure by transmitting a request message to a network entity.

In accordance with another aspect of the disclosure, The UE may only initiate the communication process when it verifies that there is enough time for the communication process to be completed before the start of the unavailability period of the satellite.

The communication process may comprise a non access stratum, NAS, procedure.

The UE may only trigger the NAS procedure when it verifies that there is enough time for the procedure to be completed before the start of the unavailability period of the satellite and loss of satellite coverage for the UE.

The UE may trigger the NAS procedure during a time range for which the procedure can be completed before the start of the unavailability period of the satellite and loss of satellite coverage for the UE.

The NAS procedure may be triggered during a time range before the UE loses coverage. The UE may trigger the NAS procedure early enough such that the procedure, under normal conditions, is able to complete before the start of a satellite unavailability period.

Verifying if the communication process can or cannot be completed before the start of the unavailability period of the satellite may comprise verifying if the NAS procedure can or cannot be completed before a related NAS timer expires.

Verifying if the NAS procedure can or cannot be successfully completed before the related NAS timer expires may comprise the UE receiving an expected NAS response message before the related NAS timer expires.

The UE would most likely verify a remaining time also based on the NAS timer of the NAS procedure and use the remaining time as a basic method to compare if there is enough time or not for the NAS procedure.

The NAS procedure may comprise any of a registration procedure, a mobility registration update procedure, an NAS request procedure, a service request procedure, an NAS mobility management procedure, an NAS session management procedure, NAS signaling, an NAS message.

Verifying if the communication process can or cannot be completed before the start of the unavailability period of the satellite may comprise verifying that there is a minimum time duration before the start of the unavailability period.

When the UE verifies that there is the minimum time duration, the UE may initiate the communication process and when the UE verifies that there is not the minimum time duration, the UE may not initiate the communication process even if a remaining flyover time of the satellite is not zero or satellite coverage is still available to the UE or the unavailability period has not yet started.

Verifying if the communication process can or cannot be completed before the start of the unavailability period of the satellite may use at least one time value.

A first time value may comprise a remaining time period between a current time and the start of the unavailability period, a second time value may comprise a time period for completion of the communication process and verifying that the communication process can be completed before the start of the unavailability period of the satellite may comprise determining that the first time value comprising the remaining time period is greater than the second time value comprising the time period for completion of the communication process.

The time period for completion of the communication process may comprise a time period between a start of a communication procedure and an end of the communication procedure of the communication process and optionally a time period for the UE to be in a state which permits start of the communication procedure.

The UE may be in any of S1 mode, N1 mode.

According to a second aspect of the disclosure there is provided a UE in a communications network using a satellite to access the network, configured to carry out the method of the first aspect.

According to a third aspect of the disclosure there is provided a communications network comprising a UE according to the second aspect and a core, the UE using the method according to the first aspect to access a satellite to access the core.

The communication process may be a process initiated by the UE. The communication process may be a process initiated by the UE on receipt of a message from the network.

The communication process may comprise an NAS communication procedure. The communication process may comprise initiation of an NAS procedure. The communication process may comprise completion of an NAS procedure.

Completion of the communications process before the start of the unavailability period of the satellite may comprise the UE transmitting a message to the network. Completion of the communications process the start of the unavailability period of the satellite may further comprise the UE receiving an expected response message from the network.

Verifying if the communication process can or cannot be completed before the start of the unavailability period of the satellite may use at least one time value. The time value may comprise a time period before an NAS timer expires. The time value may comprise a remaining time period between a current time and the start of the unavailability period. The time value may comprise a time period for completion of the communication process.

Verifying that the communication process can be completed before the start of the unavailability period of the satellite may comprise determining that the time value comprising the remaining time period is greater than the time value comprising the time period for completion of the communication process.

The time value may comprise a minimum time period. Verifying that the communication process can be completed before the start of the unavailability period of the satellite may comprise determining that the time value comprising the remaining time period is greater than or equal to the time value comprising the minimum time period.

The minimum time period may be received by the UE from the network. The minimum time period may be part of the UE subscription information. The minimum time period may be determined by the UE.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an exemplary UE according to an embodiment.

FIG. 2 is a flowchart illustrating a method of sending an NAS message by a UE according to an embodiment;

FIG. 3 illustrates a UE according to an embodiment; and

FIG. 4 illustrates a network entity according to an embodiment.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to their bibliographical meanings, but are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

Singular forms such as “a,” “an,” and “the” include plural referents unless the context clearly dictates otherwise. Thus, e.g., reference to “a component surface” includes reference to one or more of such surfaces.

While embodiments of the disclosure are described below with reference to examples that are applicable to, and use terminology associated with, 3GPP 5G, a person having ordinary skill in the art will appreciate that the techniques disclosed herein are not limited to these examples or to 3GPP 5G, and may be applied in any suitable system or standard, e.g., 3GPP 5G NR, any other relevant standard, and/or future generation wireless communication systems or standards.

For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network.

A person having ordinary skill in the art will appreciate that the disclosure is not limited to the specific examples described herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements, entities and/or messages may be added to the examples disclosed herein.
One or more non-essential elements, entities and/or messages may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed may be modified, if possible, in alternative examples.
The transmission of information between network entities is not limited to the specific form, type and/or order of messages described in relation to the examples disclosed herein.

For a UE in a communications network using a satellite to access the network, a method includes verifying if a communication process between the UE and the satellite can be completed before a start of an unavailability period of the satellite.

The above is a general UE behavior of the present disclosure. The following describes details that can be used to achieve the above aspect. These details are examples only and they may be used in any combination or order.

A method in accordance with an embodiment of the disclosure addresses problems of wasted power and unnecessary signaling overhead between a UE and a network, e.g., as a result of incomplete communication procedures.

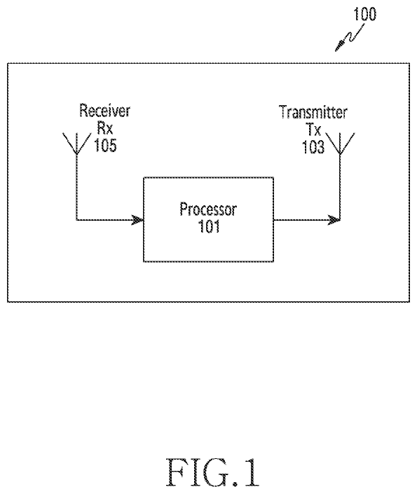

FIG. 1 is a block diagram of an exemplary UE that may be used in examples of the present disclosure. The skilled person will appreciate that the network entity illustrated in FIG. 1 may be implemented, for example, as a network element on a dedicated hardware, as a software instance running on a dedicated hardware, or as a virtualized function instantiated on an appropriate platform, e.g. on a cloud infrastructure.

The UE 100 comprises a processor (or controller) 101, a transmitter 103 and a receiver 105. The receiver 105 is configured for receiving one or more messages from one or more other entities of the communications network and the satellite. The transmitter 103 is configured for transmitting one or more messages to one or more other entities of the communications network and the satellite. The processor 101 is configured for performing operations as described below.

As described above, a flyover time of a satellite may be a time period for which the satellite provides coverage for a UE. Upon expiration of the flyover time, a DC event occurs for the UE, i.e., an unavailability period of the satellite starts.

According to an embodiment of the disclosure, a method is provided, which includes a UE verifying that a communication process can be completed before a start of an unavailability period of a satellite, and then initiating the communication process with the satellite.

If the UE cannot verify that the communication process can be completed, and then the UE determines not to initiate the communication process. This may occur even if satellite access/coverage is still available, if the remaining satellite flyover time is not zero, or if a next satellite DC event, i.e., a next unavailability period of the satellite has not yet started.

When the UE cannot verify that the communication process can be completed, the UE may keep UE access stratum functions deactivated, deactivate UE access stratum functions, remain in an idle mode, enter an idle mode, e.g., by the UE locally releasing its NAS signaling connection, staying in a current mode, remaining in a power saving mode, activating a power saving mode, and/or starting a timer to guard a release of an NAS signaling connection by a network (e.g., starting a T3540 timer in 5G or a T3440 times in long term evolution (LTE)) and after the expiry of which the UE may then enter an idle mode.

A communication process may be initiated by the UE, e.g., upon receipt of a message from a network. The message from the network may include a page. The UE may receive a page and verify whether a response to the page can be completed before a start of an unavailability period of the satellite.

A communication process may include an NAS procedure, i.e., initiation of an NAS procedure, completion of an NAS procedure, and/or an NAS message. The NAS message may include an NAS request and/or NAS signaling. The NAS signaling may be for sending data and/or requesting resources for data.

A communication process may include a radio resource control (RRC) procedure, e.g., the RSS procedure may be an RSS message.

Completing a communication process before a start of an unavailability period of the satellite may include the UE transmitting a message to the network, and then receiving an expected response message from the network.

Completion of a communication process including an NAS procedure before a start of an unavailability period of the satellite may include the UE transmitting an NAS message to the network, and then receiving an expected response message from the network. The expected response message may be an NAS response message.

In accordance with an embodiment, the NAS procedure may include a registration request message and an expected response message may be an NAS response message including a registration accept or a registration reject.

In LTE (i.e., an S1 mode), the NAS procedure may include a service request message and the expected response message may be an NAS message, e.g., a security mode command message, an indication from UE lower layers that bearers have been established, or any other indication of success of the NAS procedure in question.

A method in accordance with an embodiment of the disclosure. A method described as below is performed by a UE or a network entity.

The method may comprise verifying if the communication process can be completed before a start of an unavailability period of the satellite by using at least one time value. The time value may include a time period before an NAS timer expires.

The time value may include a remaining time period (T_rem) between a current time and a start of an unavailability period. This is basically the time period in which the satellite coverage remains available, and hence the UE can (at least in theory) initiate the communication process.

The method may include determining a start of an unavailability period. This may be equivalent to a determination of a start time of a next DC event.

The time value may include a time period for completion of the communication process.

The method may comprise verifying that the communication process can be completed before a start of an unavailability period of the satellite by determining that a first time value indicating a remaining time period is greater than a second time value indicating a time period for completion of the communication process.

The time period for completion of the communication process may include a time period between a start of a communication procedure of the communication process and an end of the communication procedure. The communication procedure may include transmission of a message by the UE.

The time period for completion of the communication process may further include a time period for the UE to be in a state which permits start of a communication procedure of the communication process.

The time period for the UE to be in a state which permits start of a communication procedure of the communication process may be zero. For example, this may occur if the UE is already in a state which permits the UE to start the communication procedure.

The method may comprise determining whether the UE is in a state that permits start of the communication procedure. For example, the state may include:
the UE's lower layers are such that they are ready to start the communication procedure without needing any GNSS fix time, or without needing Time To First Fix (TTFF),
the UE is in a 5G mobility management (5GMM)-CONNECTED mode (or evolved packet system (EPS) mobility management (EMM)-CONNECTED mode), or 5GMM-CONNECTED mode with an RRC inactive indication,
the UE is in a 5GMM-IDLE mode (or an EMM-IDLE mode), or in a 5GMM-IDLE mode with a suspend indication (or an EMM-IDLE mode with suspend indication),
the UE is in an RRC-CONNECTED state or an RRC-INACTIVE state, and/or
the UE is in an RRC-IDLE state.

Any combinations of the above may apply, however, the UE's lower layers should not need additional time to be ready to start the communication procedure.

The time period for the UE to be in a state which permits start of a communication procedure of the communication process may be non-zero. The method may include determining the non-zero time period for the UE to be in a state which permits start of the communication procedure.

The UE may not be in a state which permits start of the communication procedure, i.e., the UE needs time for the lower layers thereof to start the communication procedure. For example, the UE may need a non-zero time period to start the communication procedure due to GNSS fix time (or TTFF) due to the UE being in a cold state, a warm state, a hot state, etc.

The UE should consider the time required by its lower layers to be in a certain state, which permits the communication procedure, e.g., transmission of a message. For example, the UE may consider the time required to enter an RRC-CONNECTED state from any state that the UE may currently be in, e.g., an RRC-IDLE state. As such, when determining if there is sufficient time to complete the communication process, e.g., sending an NAS message or initiating an NAS procedure, the UE may consider at least one aspect, such as a time to fix, a time to be in an RRC-CONNECTED state, a remaining time before a start of an unavailability period of the satellite, etc.

The time value may include a minimum time period (T_min).

The method may include verifying that the communication process can be completed before a start of an unavailability period of the satellite by determining that a first time value indicating a remaining time period is greater than a second time value indicating the minimum time period.

The method may include verifying that the communication process can be completed before a start of an unavailability period of the satellite by determining that a first time value indicating a remaining time period is equal to a second time value indicating a minimum time period. When this is the case, the UE can initiate the communication process.

The method may comprise determining that the communication process cannot be completed before a start of an unavailability period of the satellite by determining that a first time value indicating a remaining time period is less than a second time value indicating minimum time period. When this is the case, the UE will not initiate the communication process.

The above-described operations may be performed by a UE in any NAS mode, e.g., an idle mode, a connected mode, an idle mode with suspend indication, or a connected mode with an RRC inactive indication (which only applies to an N1 mode, i.e., 5GS).

Herein:
an NAS idle mode may refer to: an EMM-IDLE mode (in an S1 mode), or a 5GMM-IDLE mode (in N1 mode),
an NAS idle mode with suspend indication may refer to: an EMM-IDLE mode with a suspend indication, or a 5MM-IDLE mode with a suspend indication,
an NAS connected mode may refer to: an EMM-CONNECTED mode, or a 5GMM-CONNECTED mode, and
an NAS connected mode with an RRC inactive indication may refer to: a 5GMM-CONNECTED mode with an RRC inactive indication.

The above-described operations may be performed by a UE in an S1 mode (i.e., EPS) or to a UE in an N1 mode (i.e., 5GS). For example, the UE may be in a REGISTERED or DEREGISTERED state in either the S1 mode or the N1 mode. The UE may also be in any substate of the REGISTERED or DEREGISTERED state (in either the N1 mode or the S1 mode).

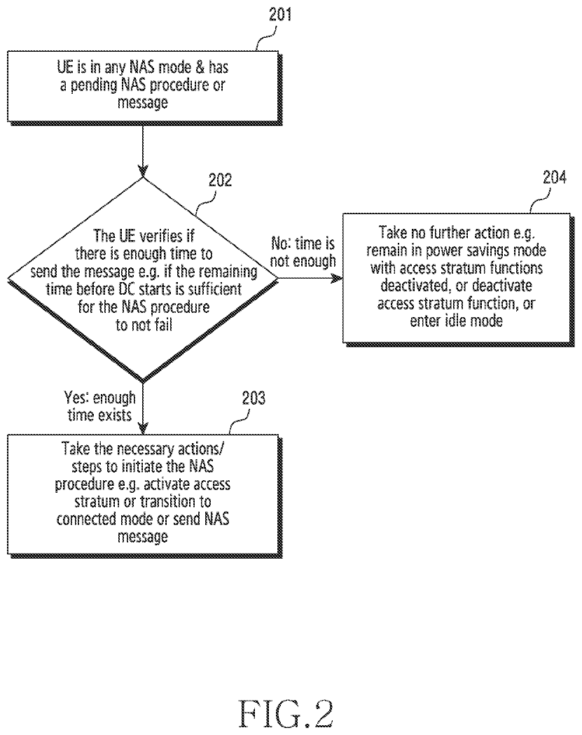

FIG. 2 is a flowchart illustrating a method of sending an NAS message by a UE according to an embodiment.

Referring to FIG. 2, in step 201, the UE is in an NAS mode and has a pending NAS procedure or NAS message to send.

In step 202, the UE determines if there is enough time to perform the pending NAS procedure or send the NAS message before DC starts.

In response to determining that there is enough time to perform the pending NAS procedure or send the NAS message before DC starts in step 202, the UE performs the pending NAS procedure or transmits the NAS message in step 203.

In response to determining that there is not enough time to perform the pending NAS procedure or send the NAS message before DC starts in step 202, the UE takes no further action in step 204. That is, the UE does not perform the pending NAS procedure or transmit the NAS message.

When a time value indicating a minimum time period (T_min) is used in the method, the UE should ensure that the minimum time period is known and/or well determined for the purpose of deciding if the communication process can be completed or not.

The minimum time period may include a value of an NAS timer associated with transmission of a communication procedure of the communication process including an NAS message, or a fraction of the value of the NAS timer associated with the transmission of the NAS message. The minimum time period may be a predetermined minimum time period. The predetermined minimum time period may be a time period associated with a mobility management message or a session management message.

The minimum time may also reflect the time required by the lower layers of the UE to be in a state that permits the transmission of a message. For example, the UE may consider the time required to enter an RRC-CONNECTED state from any state that the UE may currently be in, e.g., an RRC-IDLE state. As such, when determining if there is sufficient time to send an NAS message or initiate an NAS procedure, the UE may consider at least one aspect such as those listed herein e.g., a time to fix, a time to be in an RRC-CONNECTED state, a remaining time before a start of an unavailability period of the satellite, etc.

The minimum time period may be received by the UE from the network, e.g., in an NAS message. The NAS message may include a registration accept, an attach accept, a configuration update command, a service accept, a packet data unit (PDU) session establishment accept message, and/or any similar message that is used in EPS. The NAS message may be any new or existing message. The NAS message may be either an NAS mobility management message and/or an NAS session management message. The minimum time period may be received by the UE from the network in a container, a policy container, a part of steering information, or a part of roaming information.

The minimum time period received by the UE from the network may be associated with an NAS mobility management message, an NAS mobility management procedure, or an NAS session management message or procedure. The minimum time period received by the UE from the network may be associated with a particular message type such as a registration request, a tracking area update request, a service request, etc.

The network may determine the minimum time period based on implementation details, and/or based on knowledge of the discontinuous coverage time period, and/or based on consideration of a GNSS fix time, where this time may be the time required for the UE's lower layers to be ready for an access attempt on the satellite.

The minimum time period may be received by the UE from the network using an information element (IE) or an NAS message. The network may do so when:
the UE indicates support for handling the minimum time period, or indicates support for behaving as described herein, or indicates a new capability that is understood to imply a UE behavior in accordance with the operations herein. A UE that behaves in accordance with the operations herein should send such an indication to the network (e.g., a mobility management entity (MME), a session management function (SMF), an access and mobility management function (AMF), etc.) using an IE or an NAS message, such as a 5GMM capability IE in a registration request message, or a similar IE that is sent in an EPS NAS message,
subscription information of the UE indicates that the UE supports this feature, or supports behaving in accordance with the operations herein, or when the subscription information includes at least one minimum time value for the UE.

When the UE receives the minimum time period, e.g., per NAS mobility management and/or NAS session management, the UE uses the minimum time period as described above. The UE may store the determined value until a new value is received or determined. Any new determined value may replace an existing determined and/or stored value in the UE.

If the minimum time period is per NAS procedure type, where the procedure may be related to an NAS mobility management procedure and/or an NAS session management procedure, or the minimum time period is per NAS message type, and if the UE has an NAS procedure to initiate, then when determining whether the UE should initiate the procedure or not (e.g., as described above in FIG. 2), then the UE should use the minimum time period that is associated with the NAS procedure or message, if such an association exists. Once the minimum time period has been determined, then the UE may use the minimum time period to determine whether it can initiate the NAS procedure as described herein.

The remaining time period may be received by the UE from the network, e.g., as described above with reference to a minimum time period.

The network may provide a timer value to the UE, which is then used to determine if there is sufficient time for completion of the communication process. For example, the UE may determine that:
there is sufficient time if a remaining time period of a flyover time, i.e., before a start of an unavailability period of the satellite, is greater than (or greater than or equal to) the timer value received by the UE, and
there is not sufficient time if the remaining time period of the flyover time, i.e. before a start of an unavailability period of the satellite, is less than the timer value received by the UE.

The minimum time period may be part of UE subscription information. The minimum time period may be one value, regardless of the NAS procedure, or may be per procedure or per message of the communication process, as described above.

The network, e.g., an AMF and/or SMF, may obtain the minimum time period from the UE subscription information (e.g., from the unified data management (UDM) or home subscriber service (HSS)). Once obtained, the network may provide the minimum time period to the UE as described above. The minimum time period may also be sent using an NAS message, a container, a policy container, a part of steering information, a part of roaming information, etc.

The minimum time period may be provided to the UE by a home public land mobile network (HPLMN). The minimum time period may be provided to the UE directly using a container sent by the HPLMN in a secured manner. Once received in the UE, the UE uses the minimum time period as described herein.

The minimum time period may be determined by the UE. For example, the minimum time period, which may or may not be associated with a specific NAS procedure/message as of the communication process described above, may be configured in the UE. The UE uses this preconfigured information to determine the minimum time period and uses the minimum time period as described herein.

The UE may store the minimum time period. The UE may continue to store the minimum time period if it is using a network access that is not the satellite access, after the UE switches off, after the UE deregisters from a public land mobile network (PLMN), or changes a PLMN. Alternatively, the minimum time period may be deleted for any of the events listed and a new minimum time period may be used per PLMN once the UE registers to the PLMN. The minimum time period may be per PLMN or may apply for all PLMNs. The minimum time period may only apply for satellite access.

The descriptions above regarding the minimum time period may similarly apply to a remaining time period.

The UE may be configured to carry out the method illustrated in FIG. 2, when any of the following occurs:
the UE is preconfigured to carry out the method,
the network indicates its support for the UE to carry out the method, e.g., this support may be an explicit indication or an implicit indication, such as the network provides the remaining time period or the minimum time period to the UE, and/or
a user manually changes the settings on the UE to carry out the method.

Note that the same methods described above for carrying out the method may also be used to configure the UE to stop operating as described herein.

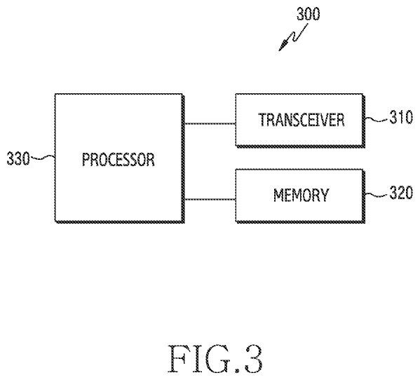

FIG. 3 illustrates a UE according to an embodiment.

Referring to FIG. 3, a UE 300 includes a transceiver 310, a memory 320, and a processor 330. The transceiver 310, the memory 320, and the processor 330 of the UE 300 may operate according to a communication method described above, e.g., as illustrated in FIG. 2. However, the components of the UE 300 are not limited thereto. For example, the UE 300 may include more or fewer components than those illustrated in FIG. 3. In addition, the processor 330, the transceiver 310, and the memory 320 may be implemented as a single chip. Also, the processor 330 may include a plurality of processors. Furthermore, the UE of FIG. 3 corresponds to the UE of the FIG. 1.

The transceiver 310 collectively refers to a UE receiver and a UE transmitter, and may transmit/receive a signal to/from a base station, satellite, or network entity. The signal transmitted or received to or from the base station, satellite, or network entity may include control information and data. The transceiver 310 may include a radio frequency (RF) transmitter for up-converting and amplifying a frequency of a transmitted signal, and an RF receiver for amplifying low-noise and down-converting a frequency of a received signal. However, this is only an example of the transceiver 310 and components of the transceiver 310 are not limited to the RF transmitter and the RF receiver.

The transceiver 310 may receive and output, to the processor 330, a signal through a wireless channel, and transmit a signal output from the processor 330 through the wireless channel.

The memory 320 may store a program and data required for operations of the UE. Also, the memory 320 may store control information or data included in a signal obtained by the UE. The memory 320 may be a storage medium, such as a read-only memory (ROM), a random access memory (RAM), a hard disk, a compact disc (CD)-ROM, a digital versatile disc (DVD), or a combination of storage media.

The processor 330 may control a series of processes such that the UE 300 operates as described above, e.g., as illustrated in FIG. 2. For example, the transceiver 310 may receive a data signal including a control signal transmitted by the base station or the network entity, and the processor 330 may determine a result of receiving the control signal and the data signal transmitted by the base station or the network entity.

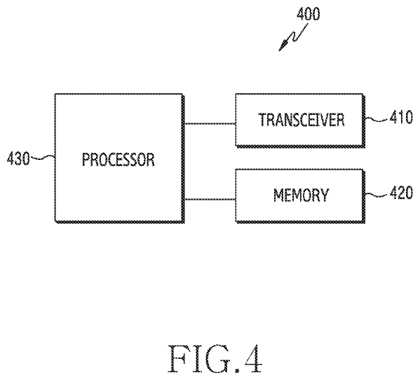

FIG. 4 illustrates a network entity according to an embodiment.

Referring to FIG. 4, a network entity includes a transceiver (410), a memory (420), and a processor (430). The transceiver (410), the memory (420), and the processor (430) of the network entity may operate according to a communication method of the network entity described above. However, the components of the network entity 400 are not limited thereto. For example, the network entity 400 may include fewer or more components than those illustrated in FIG. 4. In addition, the processor (430), the transceiver (410), and the memory (420) may be implemented as a single chip. Also, the processor (430) may include a plurality of processors.

The network entity 400 may include at least one entity of a core network. For example, the network entity 400 may include an AMF, an SMF, a policy control function (PCF), a network repository function (NRF), a user plane function (UPF), a network slicing selection function (NSSF), an authentication server function (AUSF), a UDM, and a network exposure function (NEF), but is not limited thereto.

The transceiver (410) collectively refers to a network entity receiver and a network entity transmitter, and may transmit/receive a signal to/from a base station or a UE. The signal transmitted or received to or from the base station or the UE may include control information and data. In this regard, the transceiver (410) may include an RF transmitter for up-converting and amplifying a frequency of a transmitted signal, and an RF receiver for amplifying low-noise and down-converting a frequency of a received signal. However, this is only an example of the transceiver (410) and components of the transceiver (410) are not limited to the RF transmitter and the RF receiver.

The transceiver (410) may receive and output, to the processor (430), a signal through a wireless channel, and transmit a signal output from the processor (430) through the wireless channel.

The memory (420) may store a program and data required for operations of the network entity 400. Also, the memory (420) may store control information or data included in a signal obtained by the network entity 400. The memory (420) may be a storage medium, such as a ROM, a RAM, a hard disk, a CD-ROM, a DVD, or a combination of storage media.

The processor (430) may control a series of processes such that the network entity operates as described above. For example, the transceiver (410) may receive a data signal including a control signal, and the processor (430) may determine a result of receiving the data signal.

Certain embodiments of the disclosure provide a computer program including instructions which, when the program is executed by a computer or processor, cause the computer or processor to carry out a method according to any example, embodiment, aspect and/or claim disclosed herein.

Certain embodiments of the disclosure provide a computer or processor-readable data carrier having stored therein a computer program according to the preceding examples.

Certain embodiments of the disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, etc., each element configured to perform one or more corresponding processes, operations and/or method steps for implementing the techniques described herein. For example, an operation/function of X may be performed by a module configured to perform X (or an X-module). Certain examples of the present disclosure may be provided in the form of a system (e.g., a network) including one or more such apparatuses/devices/network entities, and/or a method therefor. For example, a network may include one or more IAB nodes.

Embodiments of the disclosure may be realized in the form of hardware, software or a combination of hardware and software. Certain embodiments of the disclosure may provide a computer program including instructions or code which, when executed, implement a method, system and/or apparatus in accordance with any aspect, claim, example and/or embodiment disclosed herein. Certain embodiments of the disclosure provide a machine-readable storage storing such a program.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present disclosure.

The terms and words used herein are not limited to the bibliographical or standard meanings, but, are merely used to enable a clear and consistent understanding of the examples disclosed herein.

Throughout the description and claims, the words “comprise”, “contain” and “include”, and variations thereof, for example “comprising”, “containing” and “including”, means “including but not limited to”, and is not intended to (and does not) exclude other features, elements, components, integers, steps, processes, functions, characteristics, and the like.

Throughout the description and claims, language in the general form of “X for Y” (where Y is some action, process, function, activity or step and X is some means for carrying out that action, process, function, activity or step) encompasses means X adapted, configured or arranged specifically, but not necessarily exclusively, to do Y.

Features, elements, components, integers, steps, processes, functions, characteristics, and the like, described in conjunction with a particular aspect, embodiment, example or claim are to be understood to be applicable to any other aspect, embodiment, example, or claim disclosed herein unless incompatible therewith.

While the disclosure has been shown and described with reference to certain embodiments, it will be understood by those skilled in the art that various changes in form and detail may be made therein without departing from the scope of the disclosure, as defined by the appended claims and any equivalents thereof.

What is claimed is:

1. A method performed by a user equipment (UE) in a wireless communication system using satellite access, the method comprising:
identifying whether a non-access stratum (NAS) procedure is completable before a start of a discontinuous coverage (DC); and
in case that the NAS procedure is completable before the start of the DC, initiating the NAS procedure by transmitting a request message to a network entity.

2. The method of claim 1, further comprising, in case that the NAS procedure is not completable before the start of the DC, refraining from initiating the NAS procedure.

3. The method of claim 1, wherein the request message includes a message for the NAS procedure.

4. The method of claim 1, wherein the network entity includes an access and mobility management function (AMF) entity.

5. The method of claim 4, further comprising receiving, from the AMF entity, time information related to the start time of the DC, and
wherein identifying whether the NAS procedure is completable before the start of the DC is performed based on the time information.

6. The method of claim 5, further comprising replacing previously received time information with the time information related to the start time of the DC.

7. The method of claim 1, wherein the NAS procedure includes at least one of a registration procedure or a mobility registration update procedure.

8. The method of claim 1, wherein a completion of the NAS procedure includes receiving a response message in response to the request message.

9. The method of claim 1, wherein identifying whether the NAS procedure is completable before the start of the DC comprises identifying whether a remaining time before the start of the DC is greater than a timer value.

10. The method of claim 1, wherein identifying whether the NAS procedure is completable before the start of the DC comprises identifying whether a minimum time duration before the start of the DC remains.

11. A user equipment (UE) in a wireless communication system using satellite access, the UE comprising:
a transceiver; and
a processor coupled with the transceiver and configured to:
identify whether a non-access stratum (NAS) procedure is completable before a start of a discontinuous coverage (DC), and
in case that the NAS procedure is completable before the start of the DC, initiate the NAS procedure by transmitting a request message to a network entity.

12. The UE of claim 11, wherein the processor is further configured to, in case that the NAS procedure is not completable before the start of the DC, refrain from initiating the NAS procedure.

13. The UE of claim 11, wherein the request message includes a message for the NAS procedure.

14. The UE of according to claim 11,
wherein the network entity comprises an access and mobility management function (AMF) entity.

15. The UE of claim 11, wherein the processor is further configured to:
receive, from an access and mobility management function (AMF) entity included in the network entity, time information related to the start time of the DC, and
identify whether the NAS procedure is completable before the start of the DC, based on the time information.

16. The UE of claim 15, wherein the processor is further configured to replace previously received time information with the time information related to the start time of the DC.

17. The UE of claim 11, wherein the NAS procedure includes at least one of a registration procedure or a mobility registration update procedure.

18. The UE of claim 11, wherein a completion of the NAS procedure includes receiving a response message in response to the request message.

19. The UE of claim 11, wherein the processor is further configured to identify whether a remaining time before the start of the DC is greater than a timer value.

20. The UE of claim 11, wherein the processor is further configured to identify whether a minimum time duration before the start of the DC remains.
